(19) United States
(12) Patent Application Publication
(10) Pub. No.: US 2008/0309766 A1
(43) Pub. Date: Dec. 18, 2008

(54) COLOR CALIBRATING METHOD FOR SETTING TARGET GAMMA CURVES OF TARGET DISPLAY DEVICE

(76) Inventor: Chia-Hung Lin, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/934,786

(22) Filed: Nov. 5, 2007

(30) Foreign Application Priority Data
Jun. 12, 2007 (TW) 096121195

(51) Int. Cl. H04N 17/02

(52) U.S. Cl. 348/179; 348/E17.004

(57) ABSTRACT

The present invention discloses a color calibrating method for setting target gamma curves of a target display device by utilizing operations of color space transformation and chromaticity coordinate value comparison according to color characteristics of a reference display device. The color calibrating method disclosed by the present invention is able to measure only various gray levels of white frames, and utilize transformations between the different color spaces and comparison operation of the chromaticity coordinate value setting the target gamma curves of R, G, B for the target display device according to the color characteristics of the reference display device so as to make the color characteristics of the target display device be substantially equal to the color characteristics of the reference display device. Thus, the color calibrating method of the present invention can efficiently reduce required measuring data and time of calibrating the color characteristics of the target display device.

### BACKGROUND OF THE INVENTION

1. Field of the Invention

The present invention relates to a color calibrating method, and more particularly, to a color calibrating method for setting target gamma curves of a target display device by utilizing operations of color space transformation and chromaticity coordinate value comparison according to color characteristics of a reference display device.

2. Description of the Prior Art

It is well known that all the color calibrating methods for display devices such as LCD monitors perform color calibration via adjusting the gamma curves of red, green, and blue (R, G, B) of the LCD panel. Please refer to FIG. 1. FIG. 1 shows a simplified diagram of the conventional gamma curves of R, G, B. As shown in FIG. 1, the X axis coordinate values of the gamma curves of R, G, B commonly used in the industry are the gray level input signals of 0 to 255, and the Y axis coordinate values of the gamma curves of R, G, B are the gray level input signals of 0 to 1023. In other words, the gamma curves of R, G, B are signal transformation curves of the 8-bit input signals transforming into the 10-bit output signals.

In general, there are mainly two kinds of the conventional color calibrating methods for performing the color calibration on the LCD panel via adjusting the gamma curves of R, G, B of the LCD panel. The first kind of the conventional color calibrating method utilizes a person's eyes to adjust the gamma curves of R, G, B of a target LCD panel whose colors are required to be calibrated according to the person's sense and experience, so as to calibrate the color characteristics of the target LCD panel. However, this method obviously requires a lot of labor and time, and errors will occur easily so that the quality of the color calibration results will be greatly unstable.

The second kind of the conventional color calibrating method inputs a plurality of gray level input signals of a plurality levels (such as 256 levels) of R, G, B to a reference LCD panel which is utilized to be a golden sample, so as to output a plurality of reference patterns in the reference LCD panel. Next, the conventional color calibrating method will use a calorimeter to measure the plurality of reference patterns so as to generate a plurality of sets of first chromaticity coordinate values corresponding to a CIE-xyY color space, and then use a trial and error method to respectively change the gamma curves of R, G, B of a target LCD panel so as to try to generate a plurality of sets of second chromaticity coordinate values close or equal to the plurality of sets of first chromaticity coordinate values. However, since each of the chromaticity coordinate values in the CIE-xyY color space is linear dependent, thus when using the conventional trial and error method to find out the gamma curves of R, G, B fitting in with the characteristics of the reference LCD panel, a large amount of measuring data and respectively measuring the three colors R, G, B are required (that is, a number 256×1024×3 of data is required). In other words, this conventional color calibrating method will need to spend a very long period of time to complete the adjustment of the gamma curves of R, G, B of the target LCD panel, so as to make the color characteristics of the target LCD panel be substantially equal to the color characteristics of the reference LCD panel.

### SUMMARY OF THE INVENTION

It is therefore one of the objectives of the present invention to provide a color calibrating method for setting target gamma curves of a target display device by utilizing operations of color space transformation and chromaticity coordinate value comparison according to color characteristics of a reference display device, so as to efficiently reduce the required measuring data and time for calibrating the color characteristics of the target display device.

According to an embodiment of the present invention, a color calibrating method for setting target gamma curves of a target display device is disclosed. The color calibrating method includes: inputting a plurality of first input signals to a reference display device, so as to output a plurality of first patterns corresponding to the plurality of first input signals respectively on the reference display device; respectively measuring the plurality of first patterns to generate a plurality of sets of first chromaticity coordinate values corresponding to a first color space; respectively setting a plurality of gamma curves for the target display device and outputting a plurality of second input signals to the target display device, so as to output a plurality of second patterns corresponding to the plurality of gamma curves respectively on the target display device, the plurality of gamma curves corresponding to a second color space; respectively measuring the plurality of second patterns to generate a plurality of sets of second chromaticity coordinate values corresponding to the first color space; respectively transforming the plurality of sets of first chromaticity coordinate values and the plurality of sets of second chromaticity coordinate values to a plurality of sets of third chromaticity coordinate values and a plurality of sets of fourth chromaticity coordinate values, wherein the plurality of sets of third chromaticity coordinate values and the plurality of sets of fourth chromaticity coordinate values both correspond to the second color space; and comparing the plurality of sets of third chromaticity coordinate values with the plurality of sets of fourth chromaticity coordinate values to generate at least a target gamma curve corresponding to the second color space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of the conventional gamma curves of R, G, B.

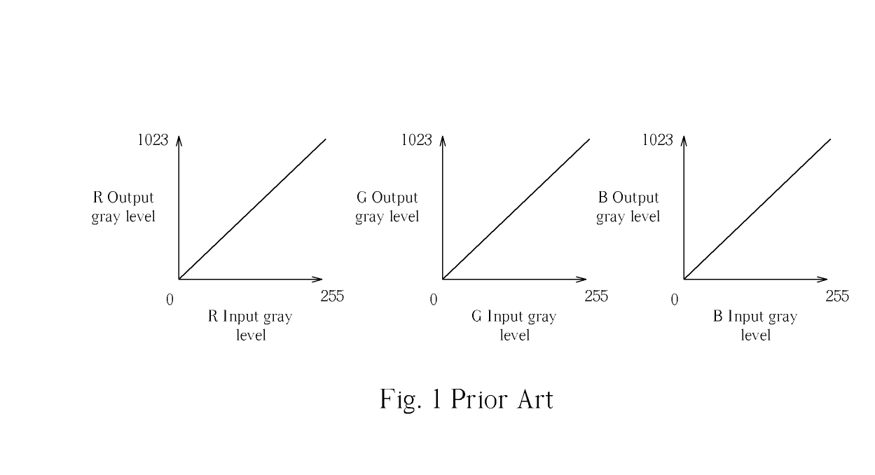

FIG. 2 shows a simplified diagram of the number 256 of sets of third chromaticity coordinate values and the number 1024 of sets of fourth chromaticity coordinate values according to an embodiment of the present invention.

FIG. 3 shows a simplified diagram of the target gamma curves of R, G, B.

FIG. 4 shows a flowchart of a first embodiment of a color calibrating method for setting target gamma curves of a target display device by utilizing operations of color space transformation and chromaticity coordinate value comparison according to color characteristics of a reference display device according to the operation schemes in the above embodiment of the present invention.

FIG. 5 shows a simplified diagram of the number 10 of sets of third chromaticity coordinate values, the number 1024 of sets of fourth chromaticity coordinate values, and the number 10 of sets of sixth chromaticity coordinate values according to an embodiment of the present invention.

FIG. 6 shows a simplified diagram of the target gamma curves of R, G, B.

FIG. 7 shows a flowchart of a second embodiment of a color calibrating method for setting target gamma curves of a target display device by utilizing operations of color space transformation and chromaticity coordinate value comparison according to color characteristics of a reference display device according to the operation schemes in the above embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

The present invention relates to a color calibrating method for setting target gamma curves of a target display device by utilizing operations of color space transformation and chromaticity coordinate value comparison according to color characteristics of a reference display device. This document will describe several exemplary embodiments that apply the method of the present invention. However, a person of average skill in the pertinent art should understand that the present invention can be applied for various types of display devices and is not limited to the particular embodiments described in the following paragraphs or to the particular manner in which any features of such embodiments are implemented.

In general, the method of the present invention is applicable to all kinds of display devices. For example, the method of the present invention can be applied for various types of display devices such as CRT monitors, LCD monitors, PDP monitors, PLED monitors, OLED monitors, or projectors, etc. A method applied for implemented for the LCD monitors is disclosed in this document. However, this is only for illustration purposes and is not meant to be a limitation of the present invention. In addition, under conditions of not affecting the technical disclosure of the present invention, the LCD monitors will be used in this document as an example to illustrate the operation principles of the method according to the present invention.

In a first embodiment, the color calibrating method of the present invention inputs a plurality of gray level input signals of a known white frame with 256 levels (for example, a number 256 of gray level input signals generated by a pattern generator, and the X axis coordinate values of the number 256 of gray level input signals in a gamma curve are respectively known 0 to 255) to a reference LCD monitor which is utilized to be a golden sample, so as to output a number 256 of first patterns corresponding to the plurality of gray level input signals of the white frame with 256 levels respectively in the reference LCD monitor. Next, the color calibrating method of the present invention will respectively measure the number 256 of first patterns (i.e. the number 256 of reference patterns) so as to generate a number 256 of sets of first chromaticity coordinate values corresponding to a CIE-xyY color space, and then respectively set a number 256 of gamma curves for a target LCD monitor and input a plurality of gray level input signals of an arbitrary white frame to the target LCD monitor, so as to output a number 256 of second patterns corresponding to the number 256 of gamma curves respectively in the target LCD monitor, and the number 256 of gamma curves correspond to a CIE-RGB color space, wherein each of the number 256 of gamma curves defines that all the different inputs correspond to a same output. In other words, if a horizontal axis represents the input gray level, and a vertical axis represents the output gray level, then a slope of each of the number 256 of gamma curves is 0. Next, the color calibrating method of the present invention will respectively measure the number 256 of second patterns to generate a number 256 of sets of second chromaticity coordinate values corresponding to the CIE-xyY color space, and then transform the number 256 of sets of first chromaticity coordinate values to a number 256 of sets of third chromaticity coordinate values and transform the number 256 of sets of second chromaticity coordinate values to a number 256 of sets of fifth chromaticity coordinate values, wherein the number 256 of sets of third chromaticity coordinate values and the number 256 of sets of fifth chromaticity coordinate values both correspond to the CIE-RGB color space. Next, the color calibrating method of the present invention will perform a linear interpolation operation on the number 256 of fifth chromaticity coordinate values to generate a number 1024 of sets of fourth chromaticity coordinate values, and then the color calibrating method of the present invention is able to compare the number 256 of sets of third chromaticity coordinate values with the number 1024 of sets of fourth chromaticity coordinate values, so as to generate a number 3 of target gamma curves of R, G, B respectively corresponding to the CIE-RGB color space.

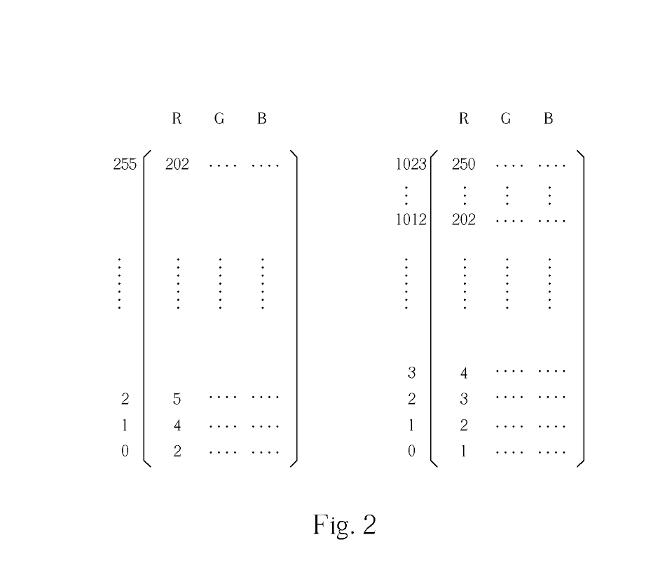

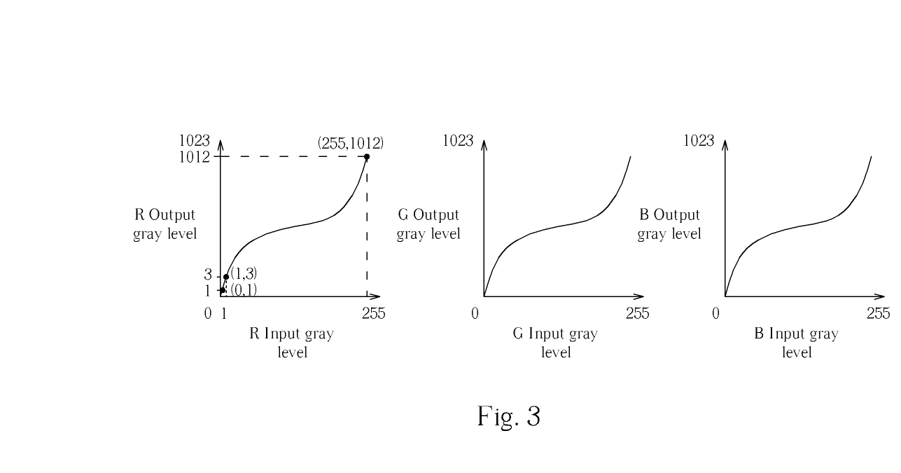

For example, please refer to FIG. 2. FIG. 2 shows a simplified diagram of the number 256 of sets of third chromaticity coordinate values and the number 1024 of sets of fourth chromaticity coordinate values according to an embodiment of the present invention. As shown in FIG. 2, when the color calibrating method of the present invention compares the number 256 of sets of third chromaticity coordinate values with the number 1024 of sets of fourth chromaticity coordinate values, it is obvious that since a R value of the 0^{th} level in the number 256 of sets of third chromaticity coordinate values is exactly equal to a R value of the 1^{th} level in the number 1024 of sets of fourth chromaticity coordinate values, thus a set of coordinate values of the 1^{th} point in the target gamma curve of R can be obtained to be (0, 1), and since a R value of the 1^{th} level in the number 256 of sets of third chromaticity coordinate values is exactly equal to a R value of the 3^{th} level in the number 1024 of sets of fourth chromaticity coordinate values, thus a set of coordinate values of the 2^{th} point in the target gamma curve of R can be obtained to be (1, 3), and the color calibrating method of the present invention will carry on by this principle, and will be able to obtain the other corresponding relations easily. In this way, the coordinate value of each point in the target gamma curve of R can be obtained, and then the target gamma curve of R can be generated by connecting the coordinate value of each point. In the same way, the target gamma curve of G and the target gamma curve of B are also generated by the same method, as shown in FIG. 3. Thus, the color calibrating method of the present invention is able to adjust the target LCD monitor according to the target gamma curves of R, G, B, so as to make the color characteristics of the target LCD monitor to be substantially the same as the color characteristics of the reference LCD monitor. Herein, please note that the above embodiment is only for illustration purposes and is not meant to be a limitation of the present invention.

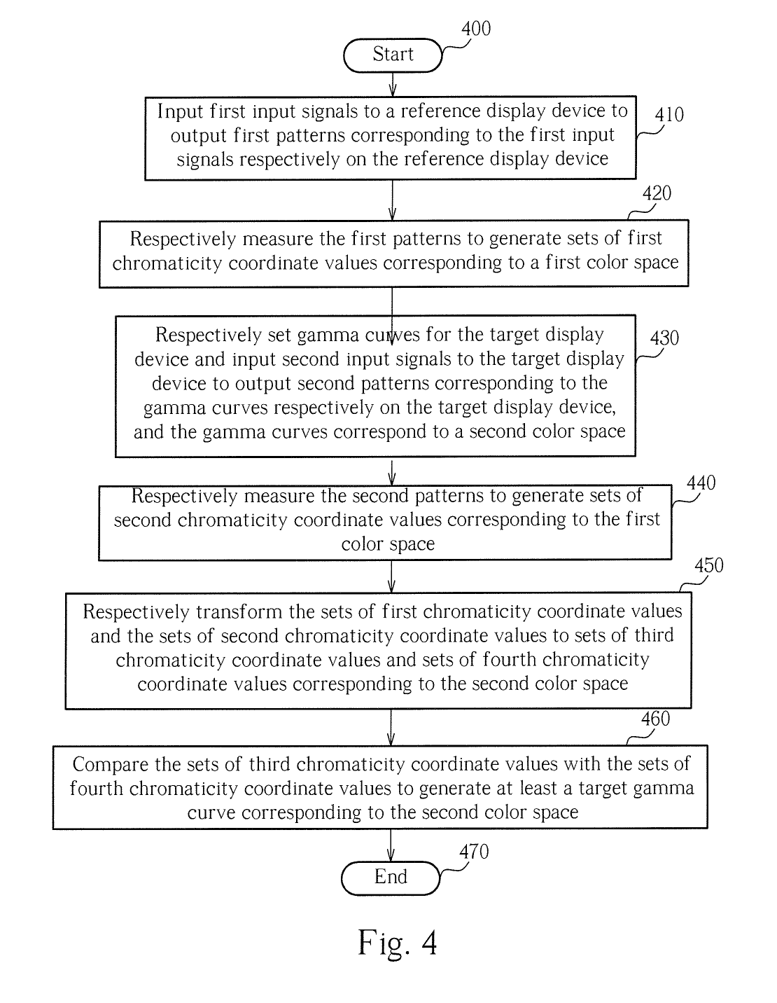

Please refer to FIG. 4. FIG. 4 shows a flowchart of a first embodiment of a color calibrating method for setting target gamma curves of a target display device by utilizing operations of color space transformation and chromaticity coordinate value comparison according to color characteristics of a reference display device according to the operation schemes in the above embodiment of the present invention. Provided that substantially the same result is achieved, the steps of the process flowchart need not be in the exact order shown and need not be contiguous, that is, other steps can be intermediate. The first embodiment of the method according to the present invention includes the following steps:

Step 400: Start.

Step 410: Input a plurality of first input signals to a reference display device, so as to output a plurality of first patterns corresponding to the plurality of first input signals respectively on the reference display device.

Step 420: Respectively measure the plurality of first patterns so as to generate a plurality of sets of first chromaticity coordinate values corresponding to a first color space, wherein the first color space is a CIE-xyY color space where each of the chromaticity coordinate values is linear dependent.

Step 430: Respectively set a plurality of gamma curves for the target display device and output a plurality of second input signals to the target display device, so as to output a plurality of second patterns corresponding to the plurality of gamma curves respectively on the target display device, and the plurality of gamma curves correspond to a second color space, wherein the second color space is a CIE-RGB color space where each of the chromaticity coordinate values is linear independent.

Step 440: Respectively measure the plurality of second patterns to generate a plurality of sets of second chromaticity coordinate values corresponding to the first color space.

Step 450: Respectively transform the plurality of sets of first chromaticity coordinate values and the plurality of sets of second chromaticity coordinate values to a plurality of sets of third chromaticity coordinate values and a plurality of sets of fourth chromaticity coordinate values, wherein the plurality of sets of third chromaticity coordinate values and the plurality of sets of fourth chromaticity coordinate values both correspond to the second color space.

Step 460: Compare the plurality of sets of third chromaticity coordinate values with the plurality of sets of fourth chromaticity coordinate values to generate at least a target gamma curve corresponding to the second color space.

Step 470: End.

In addition, please note herein that in the other embodiments of the present invention the step 440 of respectively measuring the plurality of second patterns to generate the plurality of sets of second chromaticity coordinate values can further include: measuring each of the plurality of second patterns to generate a corresponding reference chromaticity coordinate value; and performing a linear interpolation operation on a plurality of reference chromaticity coordinate values corresponding to the plurality of second patterns so as to generate the plurality of sets of second chromaticity coordinate values. In addition, the step 450 of respectively transforming the plurality of sets of first chromaticity coordinate values and the plurality of sets of second chromaticity coordinate values to a plurality of sets of third chromaticity coordinate values and a plurality of sets of fourth chromaticity coordinate values can further include: respectively transforming the plurality of sets of first chromaticity coordinate values and the plurality of sets of second chromaticity coordinate values to a plurality of sets of fifth chromaticity coordinate values and a plurality of sets of sixth chromaticity coordinate values, wherein the plurality of sets of fifth chromaticity coordinate values and the plurality of sets of sixth chromaticity coordinate values both correspond to a third color space; and respectively transforming the plurality of sets of fifth chromaticity coordinate values and the plurality of sets of sixth chromaticity coordinate values to the plurality of sets of third chromaticity coordinate values and the plurality of sets of fourth chromaticity coordinate values, wherein the third color space is a CIE-XYZ color space.

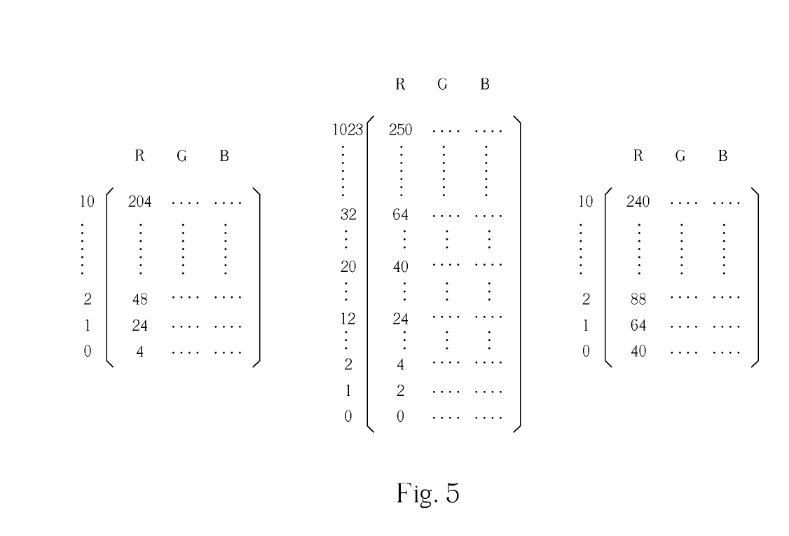

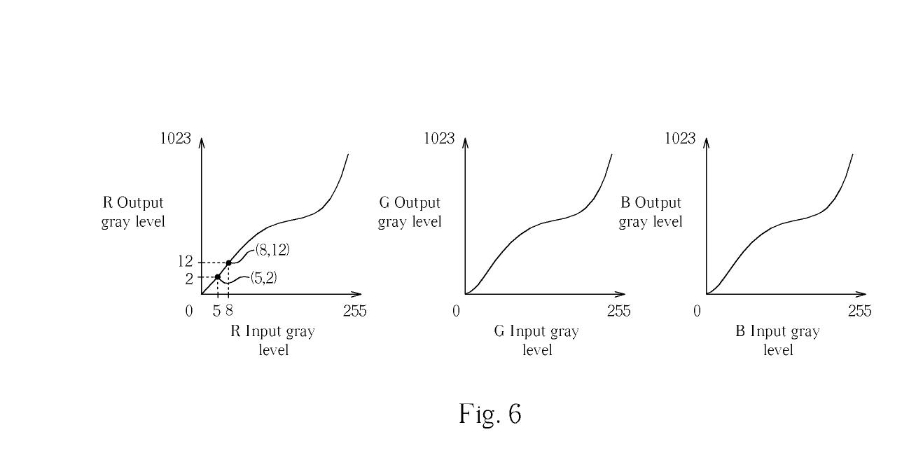

In a second embodiment, the color calibrating method of the present invention inputs a plurality of gray level input signals of a unknown white frame with 10 levels (for example, a number 10 of gray level input signals generated by a DVD player, and the X axis coordinate values of the number 10 of gray level input signals in a gamma curve are unknown) to a reference LCD monitor which is utilized to be a golden sample, so as to output a number 10 of first patterns corresponding to the plurality of gray level input signals of the white frame with 10 levels respectively in the reference LCD monitor. Next, the color calibrating method of the present invention will respectively measure the number 10 of first patterns (i.e. the number 10 of reference patterns) so as to generate a number 10 of sets of first chromaticity coordinate values corresponding to a CIE-xyY color space, and then respectively set a number 32 of gamma curves for a target LCD monitor and input a plurality of gray level input signals of an arbitrary white frame to the target LCD monitor, so as to output a number 32 of second patterns corresponding to the number 32 of gamma curves respectively in the target LCD monitor, and the number 32 of gamma curves correspond to a CIE-RGB color space, wherein each of the number 32 of gamma curves defines that all the different inputs correspond to a same output. In other words, if a horizontal axis represents the input gray level, and a vertical axis represents the output gray level, then a slope of each of the number 10 of gamma curves is 0. Next, the color calibrating method of the present invention will respectively measure the number 10 of second patterns to generate a number 32 of sets of second chromaticity coordinate values corresponding to the CIE-xyY color space, and then input a plurality of gray level input signals of the above unknown white frame with 10 levels to the target LCD monitor in the same way, so as to output a number 10 of third patterns corresponding to the plurality of gray level input signals of the white frame with 10 levels respectively in the target LCD monitor. Next, the color calibrating method of the present invention will respectively measure the number 10 of third patterns to generate a number 10 of sets of fifth chromaticity coordinate values corresponding to the CIE-xyY color space, and then transform the number 10 of sets of first chromaticity coordinate values to a number 10 of sets of third chromaticity coordinate values and transform the number 32 of sets of second chromaticity coordinate values to a number 32 of sets of seventh chromaticity coordinate values and transform the number 10 of sets of fifth chromaticity coordinate values to a number 10 of sets of sixth chromaticity coordinate values, wherein the number 10 of sets of third chromaticity coordinate values, the number 32 of sets of seventh chromaticity coordinate values, and the number 10 of sets of sixth chromaticity coordinate values all correspond to the CIE-RGB color space. Next, the color calibrating method of the present invention will perform a linear interpolation operation on the number 32 of seventh chromaticity coordinate values to generate a number 1024 of sets of fourth chromaticity coordinate values, and then the color calibrating method of the present invention is able to compare the number 10 of sets of third chromaticity coordinate values with the number 1024 of sets of fourth chromaticity coordinate values, so as to generate a number 3 of target gamma curves of R, G, B respectively corresponding to the CIE-RGB color space. For example, please refer to FIG. 5. FIG. 5 shows a simplified diagram of the number 10 of sets of third chromaticity coordinate values, the number 1024 of sets of fourth chromaticity coordinate values, and the number 10 of sets of sixth chromaticity coordinate values according to an embodiment of the present invention. As shown in FIG. 5, when the color calibrating method of the present invention compares the number 10 of sets of third chromaticity coordinate values with the number 1024 of sets of fourth chromaticity coordinate values. It is obvious that since a R value of the 0^{th} level in the number 10 of sets of third chromaticity coordinate values is exactly equal to a R value of the 2^{th} level in the number 1024 of sets of fourth chromaticity coordinate values, thus a Y axis coordinate value of the 1^{th} point in the target gamma curve of R can be obtained to be 2, and since a R value of the 0^{th} level in the number 10 of sets of sixth chromaticity coordinate values is exactly equal to a R value of the 20^{th} level in the number 1024 of sets of fourth chromaticity coordinate values, thus an X axis coordinate value of the 1^{th} point in the target gamma curve of R can be obtained to be 5 (a slope of a signal transformation curve of the 8-bit input signals transforming into the 10-bit output signals is equal to 4 when the signal transformation curve is a straight line, and thus the X axis coordinate value is equal to a result of 20 divided by 4), and thus a set of coordinate values of the 1^{th} point in the target gamma curve of R can be obtained to be (5, 2); since a R value of the 1^{th} level in the number 10 of sets of third chromaticity coordinate values is exactly equal to a R value of the 12^{th} level in the number 1024 of sets of fourth chromaticity coordinate values, thus a Y axis coordinate value of the 2^{th} point in the target gamma curve of R can be obtained to be 12, and since a R value of the 2^{th} level in the number 10 of sets of sixth chromaticity coordinate values is exactly equal to a R value of the 32^{th} level in the number 1024 of sets of fourth chromaticity coordinate values, thus an X axis coordinate value of the 2^{th} point in the target gamma curve of R can be obtained to be 8 (i.e. a result of 32 divided by 4), and thus a set of coordinate values of the 2^{th} point in the target gamma curve of R can be obtained to be (8, 12), and the color calibrating method of the present invention will carry on by this principle, and thus will be able to obtain the other corresponding relations easily. In this way, the coordinate value of each point in the target gamma curve of R can be obtained, and then the target gamma curve of R can be generated by connecting the coordinate value of each point. In the same way, the target gamma curve of G and the target gamma curve of B are also generated by the same method, as shown in FIG. 6. Thus, the color calibrating method of the present invention is able to adjust the target LCD monitor according to the target gamma curves of R, G, B, so as to make the color characteristics of the target LCD monitor to be substantially the same as the color characteristics of the reference LCD monitor. Herein, please note that the above embodiment is only for illustration purposes and is not meant to be a limitation of the present invention.

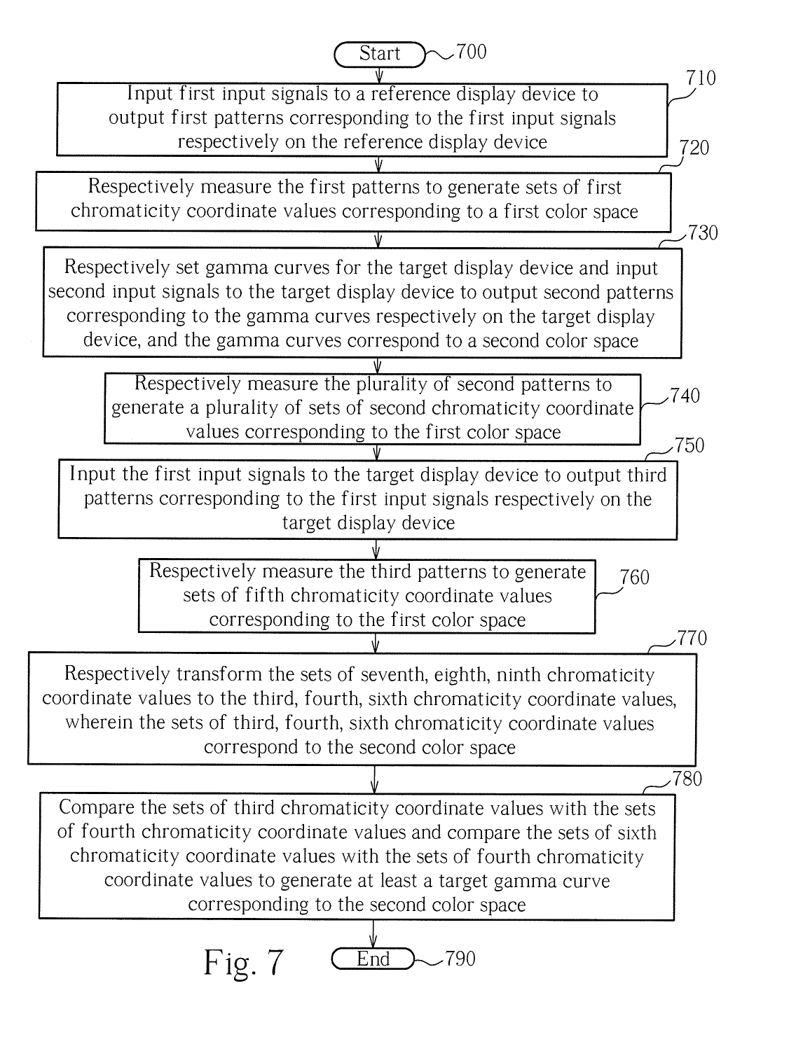

Please refer to FIG. 7. FIG. 7 shows a flowchart of a second embodiment of a color calibrating method for setting target gamma curves of a target display device by utilizing operations of color space transformation and chromaticity coordinate value comparison according to color characteristics of a reference display device according to the operation schemes in the above embodiment of the present invention. Provided that substantially the same result is achieved, the steps of the process flowchart need not be in the exact order shown and need not be contiguous, that is, other steps can be intermediate. The second embodiment of the method according to the present invention includes the following steps:

Step 700: Start.

Step 710: Input a plurality of first input signals to a reference display device, so as to output a plurality of first patterns corresponding to the plurality of first input signals respectively on the reference display device.

Step 720: Respectively measure the plurality of first patterns so as to generate a plurality of sets of first chromaticity coordinate values corresponding to a first color space, wherein the first color space is a CIE-xyY color space where each of the chromaticity coordinate values is linear dependent.

Step 730: Respectively set a plurality of gamma curves for the target display device and output a plurality of second input signals to the target display device, so as to output a plurality of second patterns corresponding to the plurality of gamma curves respectively on the target display device, and the plurality of gamma curves correspond to a second color space, wherein the second color space is a CIE-RGB color space where each of the chromaticity coordinate values is linear independent.

Step 740: Respectively measure the plurality of second patterns to generate a plurality of sets of second chromaticity coordinate values corresponding to the first color space.

Step 750: Input the plurality of first input signals to the target display device, so as to output a plurality of third patterns corresponding to the plurality of first input signals respectively on the target display device.

Step 760: Respectively measure the plurality of third patterns to generate a plurality of sets of fifth chromaticity coordinate values corresponding to the first color space.

Step 770: Respectively transform the plurality of sets of seventh chromaticity coordinate values, the plurality of sets of eighth chromaticity coordinate values, and the plurality of sets of ninth chromaticity coordinate values to the plurality of sets of third chromaticity coordinate values, the plurality of sets of fourth chromaticity coordinate values, and the plurality of sets of sixth chromaticity coordinate values, wherein the plurality of sets of third chromaticity coordinate values, the plurality of sets of fourth chromaticity coordinate values, and the plurality of sets of sixth chromaticity coordinate values all correspond to the second color space.

Step 780: Compare the plurality of sets of third chromaticity coordinate values with the plurality of sets of fourth chromaticity coordinate values and compare the plurality of sets of sixth chromaticity coordinate values with the plurality of sets of fourth chromaticity coordinate values, so as to generate at least a target gamma curve corresponding to the second color space.

Step 790: End.

In addition, please note herein that in the other embodiments of the present invention the step 740 of respectively measuring the plurality of second patterns to generate the plurality of sets of second chromaticity coordinate values can further include: measuring each of the plurality of second patterns to generate a corresponding reference chromaticity coordinate value; and performing a linear interpolation operation on a plurality of reference chromaticity coordinate values corresponding to the plurality of second patterns so as to generate the plurality of sets of second chromaticity coordinate values. In addition, the step 770 of respectively transforming the plurality of sets of seventh chromaticity coordinate values, the plurality of sets of eighth chromaticity coordinate values, and the plurality of sets of ninth chromaticity coordinate values to the plurality of sets of third chromaticity coordinate values, the plurality of sets of fourth chromaticity coordinate values, and the plurality of sets of sixth chromaticity coordinate values can further include: respectively transforming the plurality of sets of first chromaticity coordinate values, the plurality of sets of second chromaticity coordinate values, and the plurality of sets of fifth chromaticity coordinate values to a plurality of sets of seventh chromaticity coordinate values, a plurality of sets of eighth chromaticity coordinate values, and a plurality of sets of ninth chromaticity coordinate values, wherein the plurality of sets of seventh chromaticity coordinate values, the plurality of sets of eighth chromaticity coordinate values, and the plurality of sets of ninth chromaticity coordinate values all correspond to a third color space; and respectively transforming the plurality of sets of seventh chromaticity coordinate values, the plurality of sets of eighth chromaticity coordinate values, and the plurality of sets of ninth chromaticity coordinate values to the plurality of sets of third chromaticity coordinate values, the plurality of sets of fourth chromaticity coordinate values, and the plurality of sets of sixth chromaticity coordinate values, wherein the third color space is a CIE-XYZ color space.

Briefly summarized, the color calibrating method disclosed by the present invention utilizes the characteristics of the CIE-RGB color space where each of the chromaticity coordinate values is linear independent, and thus the color calibrating method of the present invention is able to measure only various gray levels of white frames, and utilize transformations between the different color spaces and comparison operation of the chromaticity coordinate value setting the target gamma curves of R, G, B for the target display device according to the color characteristics of the reference display device so as to make the color characteristics of the target display device be substantially equal to the color characteristics of the reference display device. Thus, the color calibrating method of the present invention can efficiently reduce required measuring data and time of calibrating the color characteristics of the target display device.

Those skilled in the art will readily observe that numerous modifications and alterations of the device and method may be made while retaining the teachings of the invention.

What is claimed is:

1. A color calibrating method for setting target gamma curves of a target display device, the color calibrating method comprising:
inputting a plurality of first input signals to a reference display device, so as to output a plurality of first patterns corresponding to the plurality of first input signals respectively on the reference display device;
respectively measuring the plurality of first patterns to generate a plurality of sets of first chromaticity coordinate values corresponding to a first color space;
respectively setting a plurality of gamma curves for the target display device and inputting a plurality of second input signals to the target display device, so as to output a plurality of second patterns corresponding to the plurality of gamma curves respectively on the target display device, the plurality of gamma curves corresponding to a second color space;
respectively measuring the plurality of second patterns to generate a plurality of sets of second chromaticity coordinate values corresponding to the first color space;
respectively transforming the plurality of sets of first chromaticity coordinate values and the plurality of sets of second chromaticity coordinate values to a plurality of sets of third chromaticity coordinate values and a plurality of sets of fourth chromaticity coordinate values, wherein the plurality of sets of third chromaticity coordinate values and the plurality of sets of fourth chromaticity coordinate values both correspond to the second color space; and
comparing the plurality of sets of third chromaticity coordinate values with the plurality of sets of fourth chromaticity coordinate values to generate at least a target gamma curve corresponding to the second color space.

2. The color calibrating method of claim 1, wherein each of the chromaticity coordinate values in the first color space is linear dependent, and each of the chromaticity coordinate values in the second color space is linear independent.

3. The color calibrating method of claim 2, wherein the first color space is a CIE-xyY color space.

4. The color calibrating method of claim 2, wherein the second color space is a CIE-RGB color space.

5. The color calibrating method of claim 1, wherein the step of respectively transforming the plurality of sets of first chromaticity coordinate values and the plurality of sets of second chromaticity coordinate values to the plurality of sets of third chromaticity coordinate values and the plurality of sets of fourth chromaticity coordinate values further comprises:
respectively transforming the plurality of sets of first chromaticity coordinate values and the plurality of sets of second chromaticity coordinate values to a plurality of sets of fifth chromaticity coordinate values and a plurality of sets of sixth chromaticity coordinate values, wherein the plurality of sets of fifth chromaticity coordinate values and the plurality of sets of sixth chromaticity coordinate values both correspond to a third color space; and
respectively transforming the plurality of sets of fifth chromaticity coordinate values and the plurality of sets of sixth chromaticity coordinate values to the plurality of sets of third chromaticity coordinate values and the plurality of sets of fourth chromaticity coordinate values.

6. The color calibrating method of claim 5, wherein the third color space is a CIE-XYZ color space.

7. The color calibrating method of claim 1, wherein the step of respectively measuring the plurality of second patterns to generate the plurality of sets of second chromaticity coordinate values further comprises:
measuring each of the plurality of second patterns to generate a corresponding reference chromaticity coordinate value; and
performing a linear interpolation operation on a plurality of reference chromaticity coordinate values corresponding to the plurality of second patterns so as to generate the plurality of sets of second chromaticity coordinate values.

8. The color calibrating method of claim 1, wherein the step of transforming the plurality of sets of second chromaticity coordinate values to the plurality of sets of fourth chromaticity coordinate values further comprises:
respectively transforming the plurality of sets of second chromaticity coordinate values to a plurality of sets of fifth chromaticity coordinate values; and
performing a linear interpolation operation on the plurality of fifth chromaticity coordinate values to generate the plurality of sets of fourth chromaticity coordinate values.

9. The color calibrating method of claim 1, wherein each of the plurality of gamma curves defines that different inputs all correspond to a same output.

10. The color calibrating method of claim 1, further comprising:
inputting the plurality of first input signals to the target display device, so as to output a plurality of third patterns corresponding to the plurality of first input signals respectively on the target display device;
respectively measuring the plurality of third patterns to generate a plurality of sets of fifth chromaticity coordinate values corresponding to the first color space;
transforming the plurality of sets of fifth chromaticity coordinate values to a plurality of sets of sixth chromaticity coordinate values, wherein the plurality of sets of sixth chromaticity coordinate values correspond to the second color space; and
the step of generating the target gamma curve corresponding to the second color space comprising:
comparing the plurality of sets of third chromaticity coordinate values with the plurality of sets of fourth chromaticity coordinate values and comparing the plurality of sets of sixth chromaticity coordinate values with the plurality of sets of fourth chromaticity coordinate values to generate the target gamma curve corresponding to the second color space.

11. The color calibrating method of claim 10, wherein each of the chromaticity coordinate values in the first color space is linear dependent, and each of the chromaticity coordinate values in the second color space is linear independent.

12. The color calibrating method of claim 11, wherein the first color space is a CIE-xyY color space.

13. The color calibrating method of claim 11, wherein the second color space is a CIE-RGB color space.

14. The color calibrating method of claim 10, wherein the step of respectively transforming the plurality of sets of first chromaticity coordinate values, the plurality of sets of second chromaticity coordinate values, and the plurality of sets of fifth chromaticity coordinate values to the plurality of sets of third chromaticity coordinate values, the plurality of sets of fourth chromaticity coordinate values, and the plurality of sets of sixth chromaticity coordinate values further comprises:
respectively transforming the plurality of sets of first chromaticity coordinate values, the plurality of sets of second chromaticity coordinate values, and the plurality of sets of fifth chromaticity coordinate values to a plurality of sets of seventh chromaticity coordinate values, a plurality of sets of eighth chromaticity coordinate values, and a plurality of sets of ninth chromaticity coordinate values, wherein the plurality of sets of seventh chromaticity coordinate values, the plurality of sets of eighth chromaticity coordinate values, and the plurality of sets of ninth chromaticity coordinate values all correspond to a third color space; and
respectively transforming the plurality of sets of seventh chromaticity coordinate values, the plurality of sets of eighth chromaticity coordinate values, and the plurality of sets of ninth chromaticity coordinate values to the plurality of sets of third chromaticity coordinate values, the plurality of sets of fourth chromaticity coordinate values, and the plurality of sets of sixth chromaticity coordinate values.

15. The color calibrating method of claim 14, wherein the third color space is a CIE-XYZ color space.

16. The color calibrating method of claim 10, wherein the step of respectively measuring the plurality of second patterns to generate the plurality of sets of second chromaticity coordinate values further comprises:
measuring each of the plurality of second patterns to generate a corresponding reference chromaticity coordinate value; and
performing a linear interpolation operation on a plurality of reference chromaticity coordinate values corresponding to the plurality of second patterns so as to generate the plurality of sets of second chromaticity coordinate values.

17. The color calibrating method of claim 10, wherein the step of transforming the plurality of sets of second chromaticity coordinate values to the plurality of sets of fourth chromaticity coordinate values further comprises:
respectively transforming the plurality of sets of second chromaticity coordinate values to a plurality of sets of seventh chromaticity coordinate values; and
performing a linear interpolation operation on the plurality of seventh chromaticity coordinate values to generate the plurality of sets of fourth chromaticity coordinate values.

18. The color calibrating method of claim 10, wherein each of the plurality of gamma curves defines that different inputs all correspond to a same output.
